(19) United States
(12) Patent Application Publication
(10) Pub. No.: US 2011/0115404 A1
(43) Pub. Date: May 19, 2011

(54) METHOD AND DEVICE FOR DETERMINING CALIBRATION DATA FOR AN LED LIGHT SOURCE WHILE TAKING INTO CONSIDERATION THE BARRIER LAYER TEMPERATURE

(75) Inventor: Nico Morgenbrod, Berlin (DE)

(73) Assignee: OSRAM GESELLSCHAFT MIT BESCHRAENKTER HAFTUNG, Muenchen (DE)

(21) Appl. No.: 13/054,094

(22) PCT Filed: Jun. 30, 2009
(86) PCT No.: PCT/EP2009/058151

§ 371 Date: Jan. 14, 2011

(30) Foreign Application Priority Data
Jul. 17, 2008 (DE) 10 2008 033 544.4

(51) Int. Cl. H05B 37/02; G01J 3/46; G01J 1/00

(52) U.S. Cl. 315/291; 356/402; 356/213

(57) ABSTRACT

In various embodiments, a method for determining calibration data for a light source is provided. The method may include determining at least one of a photometric quantity and a colorimetric quantity of the light source; determining a color stimulus specification using at least one of the photometric quantity and the colorimetric quantity; and determining the calibration data as a function of the color stimulus specification and a temperature of the light source.

The invention relates to a method and a device for determining calibration data, a calibration unit and a light source.

Light sources, e.g. luminous modules, LED modules, required to meet high requirements with respect to their chromaticity coordinate and chromaticity coordinate stability have to be suitably calibrated. Calibration of this kind can, for example, be performed before delivery to the customer or, in the case of activated light sources, on site.

One known approach for calibration is to use pulsed LED operation at a known ambient temperature. With this so-called “flashing”, 25 ms pulses are generated and the photometric quantity measured by means of a spectroradiometer.

One drawback hereby is that is often not possible to trigger pulses of this kind. For example, with LED modules there is no possibility of the spectroradiometer initiating the aforementioned pulses. A further drawback of “flashing” consists in the complex harmonization of the units used.

The object of the invention consists in the avoidance of the aforementioned drawbacks and especially in the provision of an efficient and versatile approach for the determination of calibration data, wherein said calibration data can be used, for example, to adjust or calibrate a light source, especially an LED module.

This object is achieved in accordance with the features of the independent claims. Developments of the invention can be derived from the dependent claims.

To achieve the object, a method is specified for determining calibration data for a light source,
wherein a photometric quantity and/or a colorimetric quantity of the light source are determined
wherein a color stimulus specification, especially a chromaticity coordinate, is determined using the photometric quantity and/or the colorimetric quantity
wherein the calibration data are determined as a function of the color stimulus specification and a temperature, especially a barrier layer temperature, of the light source.

The light source can be at least one luminous module, wherein in particular each luminous module includes at least one light-emitting diode (LED).

Advantageously, the photometric and/or the colorimetric quantity(ies) are measured by means of a suitable measuring device.

The barrier layer temperature and the photometric quantity determined can be used to perform a calibration of the light source. In particular, a calibration unit can be used to calibrate a plurality of light sources. Hence it is, for example, ensured that the plurality of light sources have substantially identical luminous properties.

Hereby, it should be noted that especially a plurality of photometric quantities or a plurality of different photometric quantities of the light source can be measured. It is also possible for a plurality of chromaticity coordinates to be determined and, on the basis of a plurality of temperatures, especially of a plurality of barrier layer temperatures of, for example, LEDs in the light source, for the calibration data to be determined.

Preferably, the calibration data are used for calibrating or adjusting the light source. To this end, the calibration data are preferably transmitted or made available to the light source via a suitable interface.

In a development, the temperature is supplied by the light source and/or requested therefrom.

In particular, the light source can have an interface to supply the temperature information, especially the barrier layer temperature(s) of the light source.

In another development, the temperature of each LED in the light source is supplied by the light source and/or requested therefrom.

In particular, in a development, the temperature of the light source is substantially taken into consideration at the time of the photometric quantity and/or colorimetric quantity determined.

Insofar, it is advantageously taken into consideration that the calibration data are based on substantially simultaneously occurring photometric and/or colorimetric quantities or temperatures.

In another development, the calibration data include a brightness, a chromaticity coordinate and/or a dominant wavelength.

Furthermore, in a development, the photometric quantity includes at least one of the following quantities:
a spectrum;
a luminous flux;
a lightness coefficient, especially a luminance and/or illuminance;
a dominant wavelength, especially a color saturation.

Within the context of an additional development, the photometric and/or colorimetric quantity is measured by means of at least one of the following components or geometries:
a spectroradiometer;
an Ulbricht sphere
a brightness sensor
a color sensor.

A next development consists in that the calibration data include a dominant wavelength, a brightness and/or color coordinates.

Hereby, it should be noted that the color stimulus specification is determined by the determination of dominant wavelength, saturation, color coordinates and/or lightness coefficient (particularly unambiguously). Hereby, the saturation can be specified as a function of the dominant wavelength and/or as function of the respective LED. This can be measured, or it can also be stored, for example in a memory.

In one embodiment, the method is performed for a plurality of color channels.

In particular, the method can be performed iteratively for one or a plurality of color channels.

An alternative embodiment consists in the fact that the calibration data are used to adjust the light source, wherein especially the calibration data are supplied to the light source.

In a next embodiment, the light source is a luminous module with at least one LED, especially with a plurality of LEDs.

The aforementioned object is also achieved by an arrangement for determining calibration data for a light source including a processor unit or a computer, which is set up so that the method described herein can be performed therewith.

Furthermore, the aforementioned object is achieved by means of a calibration unit for a light source including
a measuring device for determining a photometric and/or a colorimetric quantity of the light source
a unit for the determination of calibration data as a function of the photometric quantity and/or the colorimetric quantity and a temperature, especially a barrier layer temperature, of the light source.

Hereby, in a development, the calibration unit has a communication interface for connection to the light source.

Also specified for the achievement of the object described above is a light source for interaction with the arrangement described herein, e.g. the calibration unit, wherein the light source includes at least one temperature sensor, especially at least one NTC thermistor and/or at least one PTC thermistor for determining the temperature.

In one embodiment, a plurality of temperature sensors are arranged in different locations of the light source.

In an additional embodiment, the temperature can be determined using or taking into consideration a power output and/or a thermal resistance.

Exemplary embodiments of the invention are described and explained below with reference to the drawing, which shows:

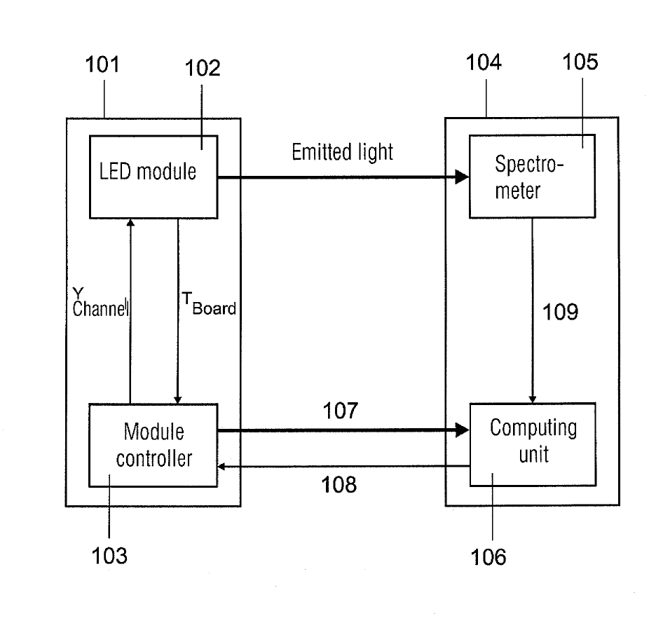

FIG. 1 an exemplary scenario including a light source (or luminous module) and a calibration unit, wherein the calibration unit can be used for determining calibration data and for adjusting the light source.

The approach described here is used especially to determine calibration data for a light source. These calibration data can be used to adjust or calibrate the light source, especially a luminous module or an LED module.

The determination of the calibration data is performed especially by means of a temperature, especially a barrier layer temperature, of the light source. Hereby, the barrier layer temperature of each individual LED in the light source is determined in dependence on the ambient temperature and in dependence on the impressed power, preferably by means of module characterization and/or by means of a temperature sensor in the light source.

### Determination of the Barrier Layer Temperature:

The chromaticity coordinate of an LED can vary as a function of the wavelength, wherein the wavelength can change with the barrier layer temperature of the LED. In addition, a luminous flux generally decreases as the temperature rises. The chromaticity coordinate and luminous flux exhibit highly non-linear behavior, especially, over a temperature profile.

Adjustable light sources with stable chromaticity coordinates, e.g. based on LEDs, compensate for such dependencies.

According to the solution proposed here, LEDs can be described mathematically so that, with knowledge of the barrier layer temperature, it is possible to determine calibration data.

Depending upon the technology and/or construction of a LED, differently pronounced thermal effects arise during the operation of the LED.

For example, as the temperature increases, a dominant wavelength of the LED is displaced in the direction of higher wavelengths and/or a luminous flux decreases as the temperature increases.

For the determination of the respective temperature curve, a large amount of measured data is preferably evaluated for each type of LED.

For the determination of the temperature, especially the barrier layer temperature of the LED, at least one temperature sensor can be provided which is coupled thermally to the LED.

In particular, different thermal sensors can be provided, including in combination with one another. It is also possible for a plurality of temperature sensors to be arranged at different positions of a luminous module. With knowledge of the positions in relation to the LED (or correspondingly to a plurality of LEDs in a luminous module), it is correspondingly possible to determine a temperature distribution between the LEDs or temperature gradients along the light source including the LEDs. This enables the barrier layer temperature of the LED to be determined with greater accuracy.

Examples of temperature sensors include: NTC thermistors (NTC), PTC thermistors (PTC), temperature sensors, thermocouples, pyrometers or the like.

With a known current impressed on the LED and with known forward voltage characteristic curves and powers of the LED and known thermal resistances and efficiencies, it is possible to determine the barrier layer temperature of the LED.

Consequently, the barrier layer temperatures of a plurality (an optional number) of LEDs can be deduced as a function of a temperature measured on a luminous module.

This enables the barrier layer temperature of the LED(s) in the light source to be determined efficiently even during operation. This enables the complex “flashing” measuring method to exclude temperature effects to be omitted.

### Calibration:

The proposed calibration of the light source proposed herein includes an approach for determining the necessary calibration data, which can then be used for the calibration e.g. by means of a calibration unit.

The calibration the light source includes especially the following steps:

(1) Measurement of at least one photometric quantity, e.g. a luminous flux, of the light source. This is performed expediently by at least one measuring device, e.g. by means of a spectroradiometer, an Ulbricht sphere, at least one color sensor, etc.

(2) Determination of a chromaticity coordinate using the at least one photometric quantity determined, e.g. using the measured spectrum. For example, a dominant wavelength and/or a chromaticity coordinate can be determined in the form of color coordinates (x, y).

(3) Reading-out or requesting the barrier layer temperature(s) of the light source. In particular, the light source can keep barrier layer temperatures ready for request via an interface or send them at predefined times. Preferably, the barrier layer temperature is synchronized with the time for the determination of the at least one photometric and/or colorimetric quantity.

(4) Determination of calibration data, e.g. lightness coefficient, dominant wavelength (color saturation), chromaticity coordinate, as a function of the barrier layer temperature of the light source. Preferably, the determination of the calibration data for a specific or required reference temperature is performed in accordance with the characteristic (and optionally stored) curves for the LEDs in the light source.

(5) Steps (1) to (4) are preferably performed for each color channel of the light source to be calibrated.

(6) The calibration data are transmitted to the light source. The light source is hence (re)set using the calibration data.

The above steps can be performed at least partially on a calibration unit.

An exemplary scenario for the use of the approach described including a light source (or luminous module) 101 and a calibration unit 104 is shown in FIG. 1.

The light source 101 includes at least one LED module 102 and at least one module controller 103, wherein the LED module 102 preferably has a plurality of LEDs. The module controller (103) is preferably disposed on the LED module in question or on an external unit for a plurality of LED modules, which is allocated to a plurality of LED modules as a central control unit. This module controller (103) includes a memory unit assigned to the respective module, on which the module calibration data associated with the LED module (102) and which is to be calibrated are stored and can be accessed during the operation of the module for the control.

The LED module 102 provides the module controller 103 with a temperature Tboard of the LED module 102, the module controller 103 transmits brightness values YChannel for each (color) channel to the LED module 102 for the adjustment of the spectral distribution and intensity. In addition, the module controller (103) calculates from the brightness values transmitted to the LED module, from the resultant electric power applied to the LED module for each color channel and from the transmitted Tboard of the LED module (102) via a thermal resistance network, the resultant barrier layer temperature (107) of the individual emitters on the LED module (102).

The LED module 102 emits light, which is absorbed by a spectrometer 105 of the calibration unit 104. The spectrometer 105 is an example of a photometric or colorimetric measuring device. Correspondingly, other measuring devices can be used in the calibration unit 104. The light acquired by the spectrometer 105 is made available in the form of measured data 109, e.g. as the chromaticity coordinate, brightness Y and/or dominant wavelength of a computing unit 106 of the calibration unit 104.

The computing unit 106 (which can be integrated in the module controller 103) receives or requests a barrier layer temperature 107 from the module controller 103 preferably at a time at which the spectrometer 104 receives the measured data. Using the measured data and the barrier layer temperature 107, the computing unit 106 determines, preferably by means of predefined LED characteristics, e.g. temperature characteristic curves stored for the respective LEDs, calibration data 108 for the required reference temperature and transmits these to the light source 101.

The calibration data 108 are especially normalized to the temperature and include a chromaticity coordinate e.g. in the form of a lightness coefficient Y0 and color coordinates (x0, y0).

### Further Advantages:

With a sufficiently exact (mathematical) description of the behavior of the light-emitting diodes (or light sources generally) over the temperature, precise calibration can be performed at any ambient temperature.

The calibration can be performed at each temperature level of the light source. Multiple calibrations of the light source in the event of a plurality of temperature conditions are not necessary. This greatly reduces the amount of calibration work. In particular, time-consuming establishment of defined temperature levels is avoided.

1. A method for determining calibration data for a light source, the method comprising:
determining at least one of a photometric quantity and a colorimetric quantity of the light source;
determining a color stimulus specification using at least one of the photometric quantity and the colorimetric quantity; and
determining the calibration data as a function of the color stimulus specification and a temperature of the light source.

2. The method as claimed in claim 1,
wherein the temperature of the light source is at least one of supplied by the light source and requested therefrom.

3. The method as claimed in claim 2,
wherein the temperature of each light emitting diode in the light source is at least one of supplied by the light source and requested therefrom.

4. The method as claimed in claim 1,
wherein the temperature of the light source is substantially taken into consideration at the time of at least one of the photometric quantity and colorimetric quantity determined.

5. The method as claimed in claim 1,
wherein the calibration data comprise at least one of a brightness, a chromaticity coordinate and a dominant wavelength.

6. The method as claimed in claim 1,
wherein the photometric quantity comprises at least one of the following quantities:
a spectrum;
a luminous flux;
a lightness coefficient; and
a dominant wavelength.

7. The method as claimed in claim 1,
wherein at least one of the photometric and colorimetric quantity is measured by means of at least one of the following components or geometries:
a spectroradiometer;
an Ulbricht sphere;
a brightness sensor; and
a color sensor.

8. The method as claimed in claim 1,
wherein the calibration data comprise at least one of a dominant wavelength, a brightness and color coordinates.

9. The method as claimed in claim 1,
wherein the method is implemented for a plurality of color channels.

10. The method as claimed in claim 1,
wherein the calibration data are used to adjust the light source.

11. The method as claimed in claim 1,
wherein the light source comprises a luminous module with at least one light emitting diode.

12. An arrangement for determining calibration data for a light source comprising:
a processor unit or a computer, which is set up to enable the performance of a method for determining calibration data for a light source, the method comprising:
determining at least one of a photometric quantity and a colorimetric quantity of the light source;
determining a color stimulus specification using at least one of the photometric quantity and the colorimetric quantity; and
determining the calibration data as a function of the color stimulus specification and a temperature of the light source.

13. A calibration unit for a light source, the calibration unit comprising:
a measuring device configured to determine at least one of a photometric and colorimetric quantity of the light source;
a unit configured to determine calibration data as a function of at least one of the photometric quantity and the colorimetric quantity and a temperature of the light source.

14. A light source for interaction with an arrangement for determining calibration data for a light source comprising:
a processor unit or a computer, which is set up to enable the performance of a method for determining calibration data for a light source, the method comprising:
determining at least one of a photometric quantity and a colorimetric quantity of the light source;
determining a color stimulus specification using at least one of the photometric quantity and the colorimetric quantity; and
determining the calibration data as a function of the color stimulus specification and a temperature of the light source,
wherein the light source comprises at least one temperature sensor configured to determine the temperature.

15. The light source as claimed in claim 14,
wherein the at least one temperature sensor comprises a plurality of temperature sensors;
wherein the plurality of temperature sensors are arranged in different locations of the light source.

16. The method as claimed in claim 1,
wherein determining a color stimulus specification comprises determining a chromaticity coordinate using at least one of the photometric quantity and the colorimetric quantity.

17. The method as claimed in claim 1,
wherein the temperature is a barrier layer temperature of the light source.

18. The method as claimed in claim 6,
wherein the dominant wavelength comprises a color saturation.

19. The light source as claimed in claim 14,
wherein the at least one temperature sensor comprises at least one of at least one NTC thermistor and at least one PTC thermistor for determining the temperature.

20. The light source as claimed in claim 15,
wherein the temperature is determined using at least one of a power output and a thermal resistance.
